(19) United States
(12) Patent Application Publication
(10) Pub. No.: US 2026/0246633 A1
(43) Pub. Date: Aug. 20, 2026

(54) PROXIMITY-BASED CREDENTIAL OPERATIONS FOR THIRD PARTY APPLICATION

(71) Applicant: Apple Inc., Cupertino, CA (US)

(72) Inventors: Sunil Nair, Fremont, CA (US); Alexander D. Pelletier, Saratoga, CA (US); Rahul Narayan Singh, Santa Clara, CA (US); Eric T. York, Cupertino, CA (US); Paul Boulay, Menlo Park, CA (US); Robin Burel, San Jose, CA (US); Venkata S. Akella, San Ramon, CA (US)

(73) Assignee: Apple Inc., Cupertino, CA (US)

(21) Appl. No.: 19/451,443

(22) Filed: Jan. 16, 2026

Related U.S. Application Data
(60) Provisional application No. 63/760,037, filed on Feb. 18, 2025.

(51) Int. Cl. H04L 9/14; H04L 9/08

(52) U.S. Cl. CPC H04L 9/14; H04L 9/0819; H04L 9/0866

(57) ABSTRACT

The present application relates to devices and components including apparatus, systems, and methods to provision a credential to a user device. In some embodiments, a physical object corresponding to the credential may be detected within a proximity of the user device for provisioning of the credential.

### CROSS-REFERENCE TO RELATED APPLICATIONS

This application claims priority to U.S. provisional Application No. 63/760,037, entitled “Proximity-based Credential Operations for Third Party Application,” filed on Feb. 18, 2025, the disclosure of which is incorporated by reference herein in its entirety for all purposes.

### TECHNICAL FIELD

The present application relates to the field of data security and, in particular, to protecting confidential information related to credentials stored on a user device.

### BACKGROUND

With the continued development and improvement of user devices, applications have developed for the devices that allow them to handle more tasks. Applications have developed to manage credentials associated with a user device and facilitate the use of the credentials by the user for performing tasks. Each of multiple applications operating on a single user device may have certain credentials that it manages. Management of these credentials can provide various challenges.

### BRIEF DESCRIPTION OF THE DRAWINGS

FIG. 1 illustrates a first part of an example representation of a procedure of provisioning a credential for a third-party application in accordance with some embodiments.

FIG. 2 illustrates a second part of the example representation of the procedure in accordance with some embodiments.

FIG. 3 illustrates a third part of the example representation of the procedure in accordance with some embodiments.

FIG. 4 illustrates a fourth part of the example representation of the procedure in accordance with some embodiments.

FIG. 5 illustrates a block diagram of an example user device in accordance with some embodiments.

FIG. 6 illustrates an example procedure for provisioning a credential in accordance with some embodiments.

FIG. 7 illustrates an example architecture or environment configured to implement techniques described herein in accordance with some embodiments.

FIG. 8 is a block diagram of an example computing device that can implement the features and processes described throughout this disclosure in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

Applications have been developed on user devices to manage credentials for users. In many instances, managing the credentials can require maintaining information related to the credentials at high security levels. Some of the credentials may be subject to regulatory bodies or standards that can require high security levels and impose penalties on applications that do not meet the high security levels. Trying to meet these high security levels can be challenging for applications, although failing to meet the high security levels can subject the application operator to liability. Further, including the instructions and/or code to ensure that the high security levels are met in each application that manages credentials on a user device can consume memory that can be limited.

Approaches described herein can include an application that may provide and manage at least a portion of the security for the third party applications. For example, the application may prevent the third party applications from accessing at least some confidential information for the credentials. Further, the application may provide encrypted data to the third party applications that can be associated with the inaccessible confidential information and that can be utilized by the third party applications in place of the confidential information to perform desired tasks. The application can ensure that the high security levels for the credentials are met by the third party applications, thereby relieving the third party applications of liability for failing to meet the high security levels. Additionally, including the instructions and/or code for maintaining the high security levels in the application rather than having the instructions and/or code repeated for each third party application can save memory.

Approaches described herein may facilitate provisioning one or more credentials to a third party application of a user device using a “tap to verify” feature available on the user device. For example, the user device may execute a third party application that corresponds to a user account of a user of the device. The user may sign into the third party application and request that the third party application provision the user account to the user device. Another application (i.e., provisioning application) running on the user device may perform a screen takeover from the third party application, where the other application presents a user interface element over a user interface of the third party application and prevents the third party application from accessing data received by the user device while the user interface element is displayed. The provisioning application may request the user to tap a physical object to the user device, where the physical object corresponds to the user account requested to be provisioned. The user may tap the object on the user device while the user interface element is displayed, and the provisioning application may verify a presence of the object and retrieve information for the object. The tap to verify procedure may proceed with provisioning the user account to the third party application based on the object being detected within the proximity of the user device.

The user device may proceed with the tap to verify feature for provisioning the financial account based on the user request. In particular, the wallet application (i.e., the provisioning application) on the user device may perform the screen takeover, where a user interface element is displayed over a user interface of the third party application and the third party application is prevented from accessing data received by the user device while the user interface element is displayed. The user may move the card within a proximity of the user device while the user interface element is displayed, and the wallet application and/or the secure element may verify a presence of the card and retrieve information for the card. The tap to verify feature may proceed with provisioning the financial account to the third party application based on the card being detected within the proximity of the user device.

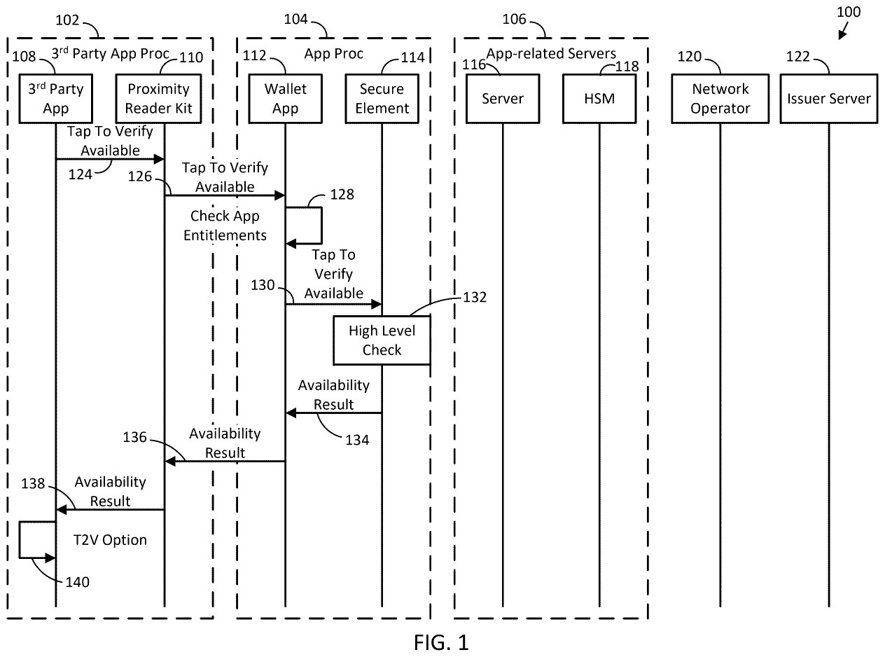

FIG. 1 illustrates a first part of an example representation 100 of a procedure of provisioning a credential for a third-party application in accordance with some embodiments. Similar operations to those that are described in the representation 100 can be utilized for verifying a credential for the third-party application, activating a credential for the third-party application, and/or determining user possession of a physical object associated with the credential.

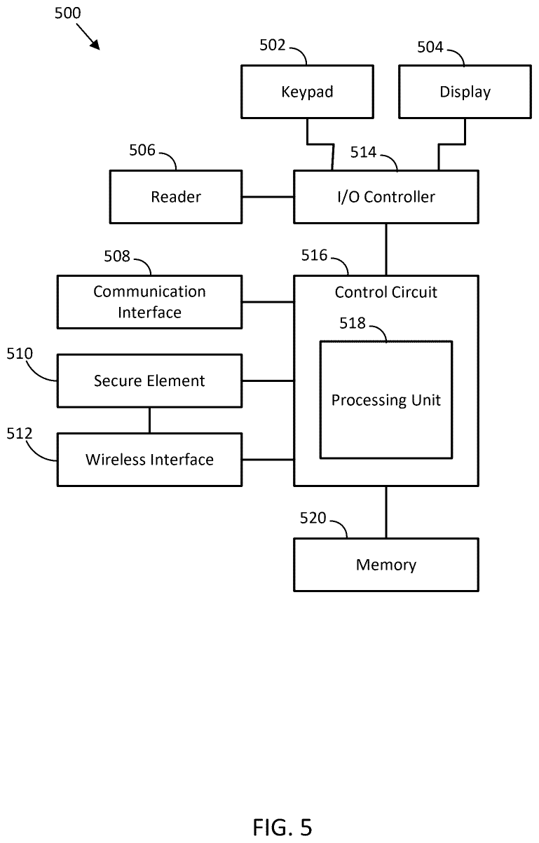

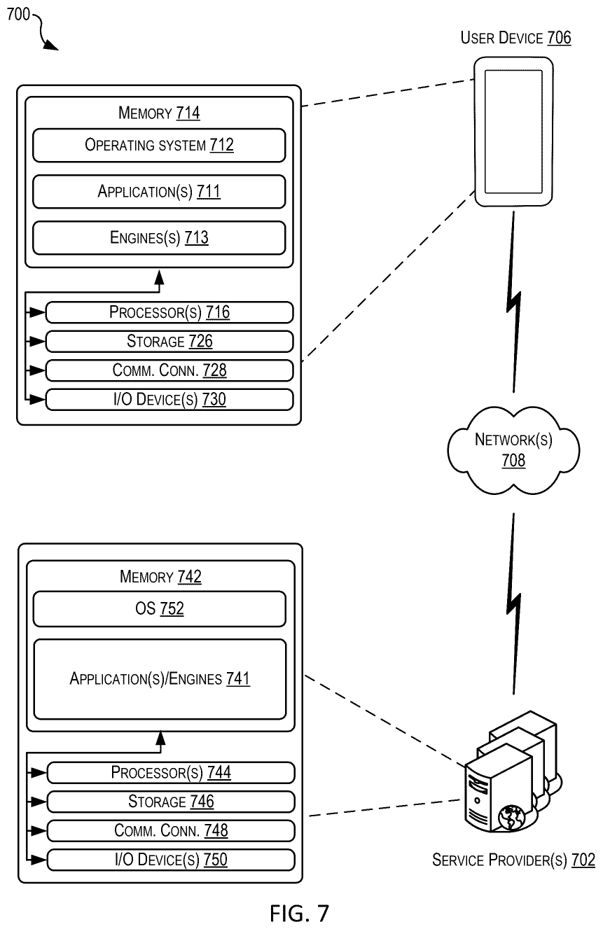

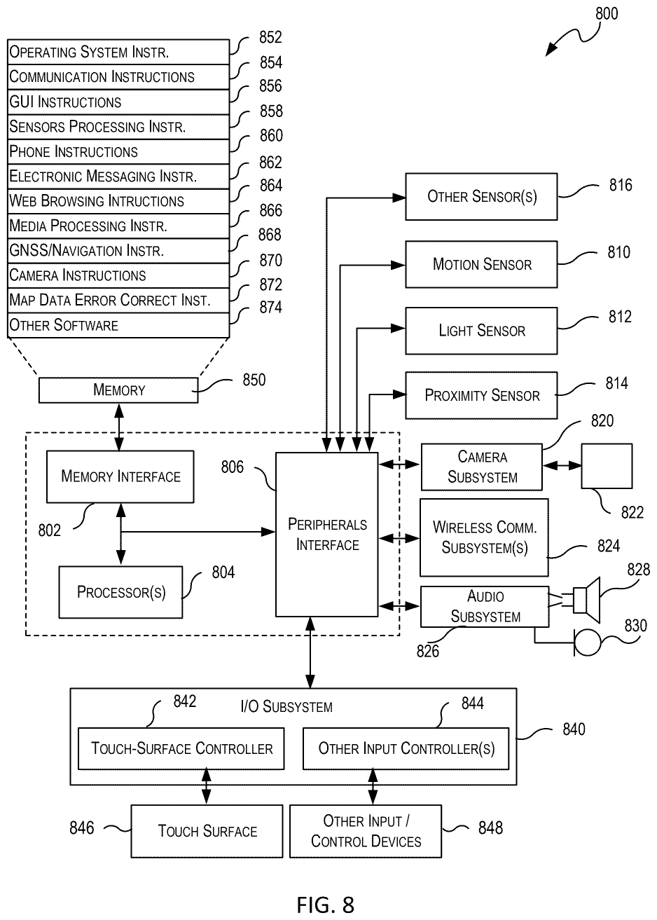

The representation 100 includes third party application procedures 102. The third party application procedures 102 includes procedures that can be performed by a third party application operating on a user device. The third party application can manage credentials that can be utilized by a user of the user device for performing a task, such as exchanging data with other devices. The user device may include one or more of the features of the user device 500 (FIG. 5), the user device 706 (FIG. 7), and/or the computing device 800 (FIG. 8).

The third party application procedures 102 may include a third party application 108. The third party application 108 may include instructions that, when executed by one or more processors of the user device, can cause the user device to perform operations, including the operations described as being performed by the third party application 108 throughout this disclosure. Some of the operations performed by the third party application 108 can result in user interfaces being displayed on the user device, user interactions with the user device being detected by the third party application 108, other interactions with the user device being detected by the third party application 108, and/or other operations of the user device being detected by the third party application 108.

In some embodiments, the third party application 108 can correspond to a particular credential or particular credentials. Other third party applications may execute on the user device, where each of the other third party applications can correspond to other particular credentials. The third party applications can be utilized for provisioning the corresponding credentials to the user device and/or for verification for utilizing the corresponding credentials by the user device, whereas the third party applications can be prevented from provisioning or verifying other credentials that do not correspond to the particular third party application.

The third party application procedures 102 may further include a proximity reader kit 110. The proximity reader kit 110 may be software that facilitates communications and/or operations between the third party application 108 and other elements of the user device (such as the wallet application 112 and/or hardware of the user device). The proximity reader kit 110 may include instructions that, when executed by one or more processors, may communicate with other elements executing on the user device to retrieve the data related to the credentials. The proximity reader kit 110 may be utilized for determining whether certain physical objects are within a proximity of the user device. In some embodiments, the physical objects may include circuitry and/or other elements that can allow the user device to wirelessly communicate and/or retrieve data from the physical objects. The physical objects may be associated with credentials, where the user device can retrieve data for the credentials from the physical objects when the physical objects are within the proximity of the user device.

The third party application procedures 102 may represent operations performed by a single third party application being executed on the user device. In some instances, multiple third party applications may be executed on a single user device, where each of the third party applications may perform one or more of the operations being performed with the third party application procedures 102 as described throughout this disclosure.

The representation 100 further includes an application procedures 104. The application procedures 104 may provide services for the third party application 108 as described throughout this disclosure.

The application procedures 104 may include a wallet application 112. The wallet application 112 may include instructions that, when executed by one or more processors of the user device, can cause the user device to perform operations, including the operations described as being performed by the wallet application 112 throughout this disclosure. In some embodiments, the wallet application 112 can manage credentials for a user of the user device. The wallet application 112 may facilitate the management of credentials with the third party application 108. For example, the wallet application 112 can communicate with one or more third party applications (including the third party application 108) to facilitate provisioning and/or verification of credentials for the third party applications.

The wallet application 112 may include an application programming interface (API). The API may allow the wallet application 112 to communicate and/or control operations of the third party application 108 and/or the proximity reader kit 110. The wallet application 112 may cause a copy of the API to be installed on the third party application 108 and/or the proximity reader kit 110. The API of the wallet application 112 may communicate with the copy of the API installed on the third party application 108 and/or the proximity reader kit 110. The APIs can facilitate a screen takeover by the wallet application 112 from the third party application 108. The screen takeover may result in a user interface element of the wallet application 112 being displayed over a user interface of the third party application 108. The screen takeover may further prevent the third party application 108 and the proximity reader kit 110 from accessing at least a portion of data received by the wallet application user interface while the wallet application user interface element is displayed over the third party user interface, as described further throughout this disclosure.

The representation 100 further includes a secure element 114. The secure element 114 may be a hardware device implemented within the user device that can operate with the wallet application 112 to facilitate performance of one or more of the application procedures 104, as described further throughout this disclosure. The secure element 114 may include one or more of the features of the secure element 510 (FIG. 5). The secure element 114 may be manufactured with security features that limit access to the secure element 114 and/or services provided by the secure element 114. For example, the secure element 114 may be manufactured with keys and/or other encryption elements assigned to the secure element 114 at manufacturing. The keys and/or other encryption elements may be utilized to access the secure element 114 and/or the services provided by the secure element 114. Limited elements may be provided the keys and/or other encryption elements, thereby limiting access to the secure element 114 and/or the services provided by the secure element 114. In the illustrated embodiment, the wallet application 112 may be provided the keys and/or other encryption elements such that the wallet application 112 can access the secure element 114 and/or the services provided by the secure element 114. The third party application 108 and the proximity reader kit 110 may not have access to the keys and/or other encryption elements and, therefore, may be prevented from accessing the secure element 114 and/or the services provided by the secure element.

The representation 100 includes application-related servers 106. The application-related servers 106 may correspond to the wallet application 112 and can provide services to the wallet application 112. The application-related servers 106 and the wallet application 112 may be managed by a same entity.

The application-related servers 106 may include a server 116 and a hardware security module (HSM) server 118. The server 116 may store information and/or provide services for the wallet application 112. The HSM server 118 may include one or more tamper-resistant hardware devices that can secure cryptographic processes. The HSM server 118 may generate, protect, and/or manage keys used for encryption and decryption of data, creation of digital signatures, and/or creation of certificates.

The representation 100 further includes a network operator server 120 and an issuer server 122. The network operator server 120 may correspond to the third party application 108. The network operator server 120 may store information and/or provide services for the third party application 108. The issuer server 122 may correspond to one or more credentials. The issuer server 122 may store information and/or provide services for the one or more credentials.

A user of the user device may access the third party application 108 on the user device. The third party application 108 may require the user to complete a login to access the third party application 108. Accordingly, the third party application 108 may verify that the user is authorized to the access the third party application 108 through the login.

The third party application 108 may perform one or more operations based on the user logging in to the third party application 108. In the illustrated embodiment, the third party application 108 may initiate an operation to determine whether tap to verify is available. In other embodiments, the operation to determine whether tap to verify is available may be initiated based on the third party application 108 being installed on the user device or based on detecting an input from the user. The third party application 108 may generate and transmit a tap to verify available request 124 to the proximity reader kit 110. The tap to verify available request 124 may inquire whether the wallet application 112 and/or the secure element 114 has tap to verify available. The tap to verify available request 124 may include information for identifying the third party application 108, information for identifying the user that signed into the third party application 108, and/or other information that may be utilized to determine whether the third party application 108 is entitled to utilize tap to verify.

The proximity reader kit 110 may receive the tap to verify available request 124 from the third party application 108. The proximity reader kit 110 may forward the tap to verify available request to the wallet application 112 in 126.

The wallet application 112 may identify the tap to verify available request received from the proximity reader kit 110. Based on the wallet application 112 identifying the request, the wallet application 112 may check the application entitlements of the third party application 108 in 128. In particular, the wallet application 112 may determine whether the third party application 108 is entitled to utilize the tap to verify feature provided by the wallet application 112 and/or the secure element 114. The wallet application 112 may utilize information included in the tap to verify available request (such as the information for identifying the third party application 108, the information for identifying the user, or other information from the request) to determine whether the third party application 108 is entitled to utilize tap to verify. If the wallet application 112 determines that the third party application 108 is entitled to utilize the tap to verify feature, the wallet application 112 may forward the tap to verify available request to the secure element 114 in 130. If the wallet application 112 determines that the third party application 108 is not entitled to utilize the tap to verify feature, the procedure may proceed to 136 where the wallet application 112 indicates that the third party application 108 is not entitled to utilize the tap to verify feature.

The secure element 114 may identify the tap to verify available request received from the wallet application 112. Based on identifying the tap to verify available request, the secure element 114 may perform a high level check 132 to determine whether tap to verify is available. For example, the secure element 114 may determine whether tap to verify is available based on whether a near field communication (NFC) radio of the user device is available, whether the secure element 114 has memory available for the tap to verify feature, and/or a state of the secure element 114. The secure element 114 may generate and transmit an availability result 134 to the wallet application 112. The availability result 134 may indicate whether the tap to verify is available based on the determination.

In instances where the wallet application 112 had determined that the third party application 108 is not entitled to utilize the tap to verify feature in 128, the wallet application 112 may generate and transmit an availability result to the proximity reader kit 110 in 136 that indicates that the tap to verify feature is unavailable. In instances where the wallet application 112 receives the availability result from the secure element 114, the wallet application 112 may forward the availability result from the secure element 114 to the proximity reader kit 110 in 136.

The proximity reader kit 110 may identify the availability result received from the wallet application 112. The proximity reader kit 110 may forward the availability result to the third party application 138.

The third party application 108 may identify the availability result received from the proximity reader kit 110. If the third party application 108 determines that the availability result indicates that tap to verify is unavailable, the third party application 108 may terminate the procedure. If the third party application 108 determines that the availability result indicates that tap to verify is available, the third party application 108 may cause a user interface to be displayed on the user device that provides the option of tap to verify in 140.

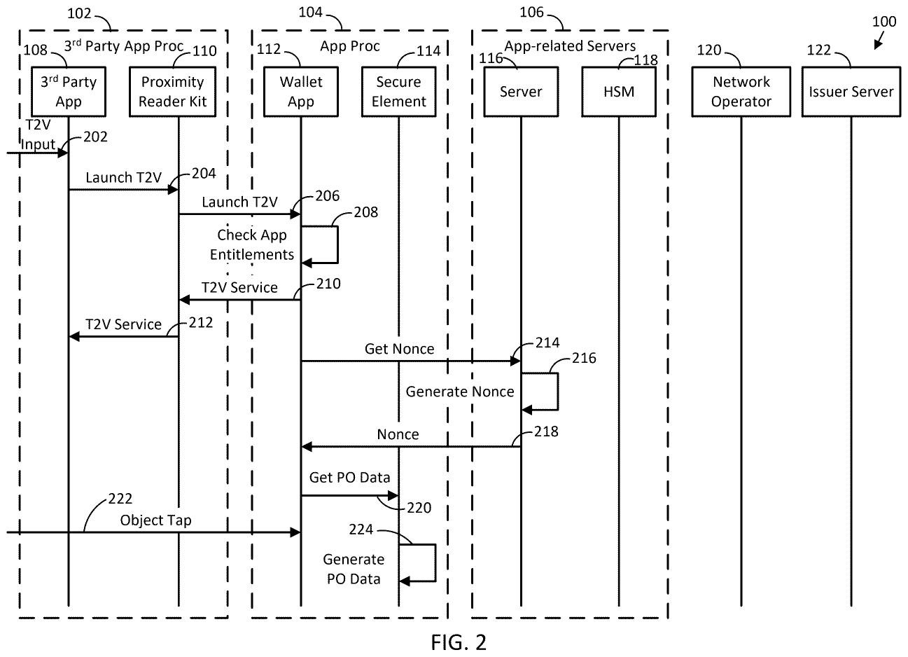

The procedure may proceed to FIG. 2. FIG. 2 illustrates a second part of the example representation 100 of the procedure in accordance with some embodiments.

The third party application 108 may identify a tap to verify (T2V) input in 202. For example, the third party application 108 may identify an input of the user to the user device that indicates that the user wants to utilize the tap to verify feature. The input of the user may be identified in the user interface displayed in 140 with the option of the tap to verify. Based on the third party application 108 identifying the tap to verify input, the third party application 108 may generate and transmit a launch tap to verify request to the proximity reader kit 110 in 204. The launch tap to verify request may include information for identifying the third party application 108, information for identifying the user that signed into the third party application, and/or other information that may be utilized to determine whether the third party application 108 is entitled to utilize tap to verify. In some embodiments, the launch tap to verify request may include a flow with tap or tap with pin (flow: .tap|.tapWithPin).

The proximity reader kit 110 may identify the launch tap to verify request received from the third party application. The proximity reader kit 110 may forward the launch tap to verify request to the wallet application in 112.

The wallet application 112 may identify the launch tap to verify request received from the proximity reader kit 110. Based on the wallet application 112 identifying the request, the wallet application 112 may check the application entitlements of the third party application 108 in 208. In particular, the wallet application 112 may determine whether the third party application 108 is entitled to have the tap to verify feature launched by the wallet application 112 and/or the secure element 114 for use by the third party application 108. The wallet application 112 may utilize information included in the launch tap to verify request (such as the information for identifying the third party application 108, the information for identifying the user, or other information from the request) to determine whether the third party application 108 is entitled to have the tap to verify feature launched.

If the wallet application 112 determines that the third party application 108 is not entitled to have the tap to verify feature launched, the wallet application 112 may terminate the procedure. If the wallet application 112 determines that the third party application 108 is entity to have the tap to verify feature launched, the wallet application 112 may generate and transmit a tap to verify service message to the proximity reader kit 110 in 210. The tap to verify service message may be generated by the API on the wallet application 112. The tap to verify service message may communicate with the copy of the API on the third party application 108 and/or the proximity reader kit 110 to cause the screen lockout to be performed. For example, the wallet application 112 may cause a user interface element to be displayed over a user interface of the first application at 210. The tap to verify service message may instruct the copy of the API on the third party application 108 and/or the proximity reader kit 110 to prevent the third party application 108 and the proximity reader kit 110 from accessing data received by the user device while the user interface element is displayed over the user interface.

The proximity reader kit 110 may identify the tap to verify service message received from the wallet application 112. The proximity reader kit 110 may forward the tap to verify service message to the third party application 108 in 212. The third party application 108 may identify the tap to verify service message received from the third party application 108. Based on the tap to verify service message being received, the copy of the API on the third party application 108 and/or the proximity reader kit 110 may prevent the third party application 108 and the proximity reader kit 110 from accessing data received by the user device. For example, the API and the copy of the API may develop a sandbox for the wallet application 112, where the third party application 108 is prevented from accessing data from the wallet application 112 and/or data received by the user device.

The wallet application 112 may generate and transmit a get nonce request to the server 116 in 214. The get nonce request may request a nonce from the server. In some embodiments, the get nonce request may include a device region indication (deviceRegion) for the user device, a country code indication (countryCode) for the user device, and/or a transaction identifier (txID).

The server 116 may identify the get nonce request received from the wallet application. Based on the server 116 identifying the get nonce request, the server 116 may generate a nonce in 216. In some embodiments, the server 116 may generate the nonce based on information included in the get nonce request, such as the device region indication, the country code indication, and/or the txID. The server 116 may transmit the nonce to the wallet application 112 in 218. In some embodiments, the transmission with the nonce may include the country code and/or a currency code (currencyCode) corresponding to the user device.

The wallet application 112 may identify the nonce received from the server 116. Due to the copy of the API preventing the third party application 108 and the proximity reader kit 110 from accessing data received by the user device while the user interface element is displayed over the user interface (such as via the sandboxing of the wallet application 112), the third party application 108 and the proximity reader kit 110 may be unable to access the nonce received by the wallet application 112 on the device. The wallet application 112 may store the nonce.

The wallet application 112 may generate and transmit a get physical object data message 220 to the secure element 114. In some embodiments, the get physical object data message may include the nonce, the country code, and/or the currency code. The get physical object data message may request the secure element 114 to obtain data related to a credential from a physical object corresponding to the credential.

The secure element 114 may identify the get physical object data message received from the wallet application 112. Based on identifying the get physical object data message, the secure element 114 may activate one or more hardware elements of the user device to monitor for the presence of the physical object corresponding to the credential. For example, the secure element 114 may activate a wireless interface (such as the wireless interface 512 (FIG. 5)), and/or a reader (such as the reader 506 (FIG. 5)) of the user device. When activating, the one or more hardware element may monitor for the presence of the physical object.

A user may tap the physical object to, or otherwise cause the physical object to interact with, the user device in 222. For example, the user may move the physical object within a proximity of the user device, or swipe the physical object through or against the reader to read a magnetic stripe of the physical object. The secure element 114, via the one or more activated hardware elements, may detect the presence of the physical object. The secure element 114 may retrieve information from the physical object, such as identifying information for the credential stored on the physical object. In some embodiments, the physical object may include a tag that stores the information and the secure element 114 may read, via the one or more activated hardware elements, the information from the tag. Due to the copy of the API preventing the third party application 108 and the proximity reader kit 110 from accessing data received by the user device while the user interface element is displayed over the user interface (such as via the sandboxing of the wallet application 112), the third party application 108 and the proximity reader kit 110 may be unable to access the information retrieved from the physical object.

The secure element 114 may generate physical object data in 224. The secure element may generate the physical object data using the information retrieved from the physical object and/or information received from the server 116. In some embodiments, the secure element 114 may utilize the nonce, the country code, and/or the currency code to generate the physical object data. The secure element 114 may keep a funding primary account number (fpan) in session in some embodiments. For example, the secure element 114 may store an fpan corresponding to the credential (where the fpan may be retrieved from the physical object) while a session for the current iteration of the procedure is ongoing.

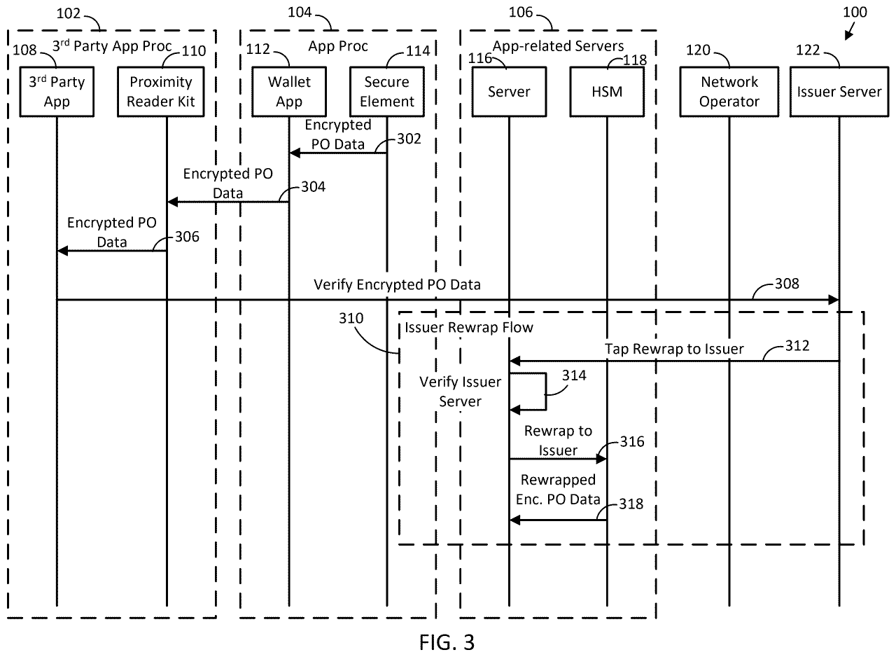

The procedure may proceed to FIG. 3. FIG. 3 illustrates a third part of the example representation 100 of the procedure in accordance with some embodiments.

The secure element 114 may encrypt the physical object data generated in 224. The encryption of the physical object data may prevent the wallet application 112, the proximity reader kit 110, and/or the third party application 108 from accessing the original physical object data, where the original physical object data may include the information retrieved from the physical object. The secure element 114 may provide the encrypted physical object data to the wallet application 112 in 302. In some embodiments, the secure element 114 may further provide the encrypted physical object data to the network operator server 120 and/or the issuer server 122. The secure element 114 may provide the encrypted physical object data to the server 116 in some embodiments.

The wallet application 112 may identify the encrypted physical object data received from the secure element 114. The wallet application 112 may forward the encrypted physical object data to the proximity reader kit 110 in 304.

The proximity reader kit 110 may identify the encrypted physical object data received from the wallet application 112. The proximity reader kit 110 may forward the encrypted physical object data to the third party application 108 in 306.

The third party application 108 may identify the encrypted physical object data received from the proximity reader kit 110. The third party application 108 may generate and transmit a verify encrypted physical object data request to the issuer server in 308. The verify encrypted physical object data request may include the encrypted physical object data and may request that the issuer server 122 verify the encrypted physical object data.

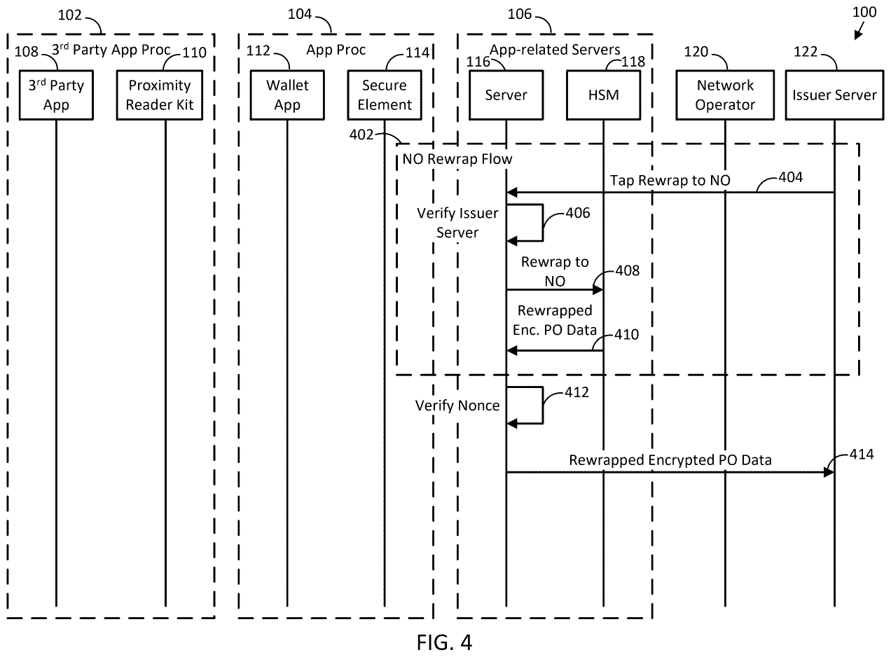

The procedure may proceed to FIG. 4. FIG. 4 illustrates a fourth part of the example representation 100 of the procedure in accordance with some embodiments.

The issuer server 122 may identify the encrypted physical object data request received from the third party application 108. Based on the issuer server 122 identifying the encrypted physical object data request, the issuer server 122 may proceed with one of two rewrap flows. In particular, the issuer server 122 may proceed with an issuer rewrap flow 310 or a network operator (NO) rewrap flow 402.

In the issuer rewrap flow 310, the issuer server 122 may generate and transmit a tap rewrap to issuer request to the server 116 in 312. The tap rewrap to issuer request may include the encrypted physical object data and/or an issuer identifier, where the issuer identifier may correspond to the issuer server 122 and/or an operator of the issuer server.

The server 116 may identify the tap rewrap to issuer request received from the issuer server 122. The server 116 may verify the issuer server 122 in 314. For example, the server 116 may verify that the issuer server 122 is authorized to have the encrypted data rewrapped to the issuer server 122. The server 116 may verify that the issuer server 122 is authorized based on the issuer identifier. If the server 116 determines that the issuer server 122 is not authorized to have the encrypted data rewrapped, the server 116 may end the procedure. If the server 116 verifies that the issuer server 122 is authorized to have the encrypted data rewrapped to the issuer server 122, the server 116 may generate and transmit a rewrap to issuer request to the HSM server 118 in 316. The rewrap to issuer request may include the encrypted physical object data and/or the issuer identifier.

The HSM server 118 may identify the rewrap to issuer request received from the server 116. The HSM server 118 may rewrap the encrypted physical object data to the issuer server 122 in 318. In some embodiments, rewrapping the encrypted physical object data may include encrypting or re-encrypting the physical object data with a key corresponding to the issuer server 122. Further, the HSM server 118 may transmit the rewrapped encrypted physical object data to the server 116 in 318.

In the network operator rewrap flow 402, the issuer server 122 may generate and transmit a tap rewrap to network operator request to the server 116 in 404. The tap rewrap to network operator request may include the encrypted physical object data, an issuer identifier, and/or a network operator identifier, where the network operator identifier may correspond to the network operator server 120 and/or the network operator.

The server 116 may identify the tap rewrap to network operator request received from the issuer server 122. The server 116 may verify the issuer server 122 in 406. For example, the server 116 may verify that the issuer server 122 is authorized to have the encrypted data rewrapped to the network operator server 120. The server 116 may verify that the issuer server 122 is authorized based on the issuer identifier. If the server 116 determines that the issuer server 122 is not authorized to have the encrypted data rewrapped, the server 116 may end the procedure. If the server 116 verifies that the issuer server 122 is authorized to have the encrypted data rewrapped to the network operator server 120, the server 116 may generate and transmit a rewrap to network operator request to the HSM server 118 in 316. The rewrap to network operator request may include the encrypted physical object data, and/or the network operator identifier.

The HSM server 118 may identify the rewrap to network operator request received from the server 116. The HSM server 118 may rewrap the encrypted physical object data to the network operator in 318. In some embodiments, rewrapping the encrypted physical object data may include encrypting or re-encrypting the physical object data with a key corresponding to the network operator server 120. Further, the HSM server 118 may transmit the rewrapped encrypted physical object data to the server 116 in 410.

The server 116 may identify the rewrapped encrypted physical object data received from the HSM server 118. The server 116 may verify the nonce and/or the txID in 412. For example, the server 116 may verify that nonce information and/or txID information in the rewrapped encrypted physical object data matches the nonce and/or the txID previously generated and/or received.

The server 116 may transmit the rewrapped encrypted physical object data to the issuer server 122 in 414. The issuer server 122 may store the rewrapped encrypted physical object data for subsequent use in operations.

FIG. 5 illustrates a block diagram of an example user device 500 in accordance with some embodiments. The block diagram illustrates various example components and features of the example user device 500.

The user device 500 may include a secure element 510, a wireless interface 512, a reader 506 (such as a magnetic card reader that can read a magnetic stripe of a physical object), a communication interface 508, a control circuit 516, a processing unit 518 on which an operating system (OS) of the user device 500 is running, an input/output (I/O) Controller 514, a display 504, a keypad 502, and/or a memory 520. Examples of OS running on the processing unit 518 may include, but are not limited to, a version of iOS®, or a derivative thereof, available from Apple Inc.; a version of Android OS®, or a derivative thereof, available from Google Inc.; a version of PlayBook OS®, or a derivative thereof, available from RIM Inc. It is understood that other proprietary OS or custom made OS may be equally used without departing from the scope of the present invention.

In some embodiments, the user device 500 may be controlled by the processing unit 518 and/or the control circuit 516 to provide the processing capability required to execute the OS of the user device 500. The processing unit 518 may include a single processor or a plurality of processors. For example, the processing unit 518 may include “general purpose” microprocessors, a combination of general and special purpose microprocessors, instruction set processors, graphic processors, or special purpose processors. The control circuit 516 may include one or more data buses for transferring data and instructions between components of the user device 500. The control circuit 516 may also include on board memory for caching purposes.

In some embodiments, information used by the processing unit 518 may be located in the memory 520. The memory 520 may be a non-volatile memory such as read only memory, flash memory, a hard drive, or any other suitable optical, magnetic, or solid-state computer readable media, as well as a combination thereof. The memory 520 may be used for storing data required for the operation of the processing unit 518 as well as other data required for the user device 500. For example, the memory 520 may store the firmware of the user device 500. The firmware may include the OS, as well as other programs that enable various functions of the user device 500, graphical user interface (GUI) functions, or processor functions. The memory 520 may store components for a GUI, such as graphical elements, screens, and templates. The memory 520 may also include data files such as connection information (e.g. information used to establish a communication), or data allowing the user device 500 to run the third party application 108 (FIG. 1), the proximity reader kit 110 (FIG. 1), and/or the wallet application 112 (FIG. 1). The data stored in the memory 520 may allow the user device 500 to perform the operations described in relation to the representation 100 (FIG. 1), such as data to generate user interfaces on the display 504 utilized during performance of the operations. In addition, the memory 520 may store data to control the activation/deactivation of the wireless interface 512 and, when activated, control the operation mode of the wireless interface 512 (e.g., passive or active).

The communication interface 508 may provide additional connectivity channels for receiving and transmitting information. For example, the communication interface 508 may provide connectivity functions to allow the user device 500 to communicate with the server 116 (FIG. 1), the HSM server 118 (FIG. 1), the network operator server 120 (FIG. 1), and/or the issuer server 122 (FIG. 1). The communication interface 508 may represent, for example, one or more network interface cards (NIC) or a network controller as well as associated communication protocols. The communication interface 508 may include several types of interfaces, including but not limited to, a wireless local area network (WLAN) interface, a local area network (LAN) interface, a wide area network (WAN) interface, a multimedia message service (MMS), and a short message service (SMS) interface.

In certain embodiments, the user device 500 may use a device identification networking protocol to establish a connection with an external device through a network interface. For example, both the user device 500 and the external device may broadcast identification information using internet protocol (IP). The devices may then use the identification information to establish a network connection, such as a LAN connection, between the devices.

The wireless interface 512 may allow for close range communication at various data rates complying, for example, with standards such as ISO 14443, ISO 15693, ISO 18092 or ISO 21481. In some embodiments, the wireless interface 512 may be implemented through a near file communication (NFC) device embedded in a chipset that is part of the user device 500. Alternatively the wireless interface 512 may be implemented through an NFC device that is a separate component and that communicates through the communication interface 508 with the user device 500, or through an additional port of the user device 500. The wireless interface 512 may include one or more protocols, such as the Near Field Communication Interface and Protocols (NFCIP-1) for communicating with another NFC enabled device. The protocols may be used to adapt the communication speed and to designate one of the connected devices as the initiator device that controls the near field communication. In certain embodiments, the wireless interface 512 may be used to receive information, such as the service set identifier (SSID), channel, and encryption key, used to connect through another communication interface. In one embodiment of the present invention, the wireless interface 512 is in direct communication with the secure element 510 and/or the control circuit 516. In other embodiments, the wireless interface 512 may be connected, for example but without being limitative, to the control circuit 516, the I/O controller 514, or both.

The wireless interface 512 may control the near field communication mode of the user device 500. For example, the wireless interface 512 may be configured to switch the user device 500 between a reader/writer mode for reading NFC tags, a peer-to-peer mode for exchanging data with another NFC enabled device, and a card emulation mode for allowing another NFC enabled device to read data. The wireless interface 512 also may be configured to switch the user device 500 between an active mode where the user device 500 generates its own RF field and a passive mode where the user device 500 uses load modulation to transfer data to another device generating an RF field. Operation in passive mode may prolong the battery life of the user device 500. In certain embodiments, the modes of the wireless interface 512 may be controlled based on user or manufacturer preferences.

In an embodiment, the wireless communication of the wireless interface 512 may occur within a range of approximately 2 to 4 cm. The close range communication with the wireless interface 512 may take place via magnetic field induction, allowing the wireless interface 512 to communicate with other NFC devices or to retrieve data from tags having RFID circuitry. The wireless interface 512 may be used to acquire data from the physical objects (such as NFC-enabled cards) or from other devices.

The secure element 510 may be embodied in a chipset connected to the control circuit 516 that cooperates with the wireless interface 512 to provide operations described in relation to the procedure of the representation 100 in some embodiments. In other embodiments, the secure element 510 may be embodied in a chipset connected to the control circuit 516 that cooperates with the reader 506 to retrieve data from physical objects. In some other embodiments, the secure element 510 may be embodied in a chipset connected to the control circuit 516 that cooperates with the reader 506 to provide the operations described in relation to the representation 100. For example, but without being limitative, the chipset on which the secure element 510 is embodied may be a model of the ST32® or ST33® chipset family, or a derivative thereof, available from STMicroelectronics Inc.

In some embodiments, the secure element 510 may be manufactured with security features that may not be provided after manufacturing and which may limit access to the secure element 510. For example, the secure element 510 may be assigned one or more keys and/or other security elements at the time of manufacturing. The sharing of the keys and/or other security elements may be limited after manufacturing, which can limit bad actors from obtaining the keys and/or other security elements.

The I/O Controller 514 may provide the infrastructure for exchanging data between the control circuit 516, the processing unit 518, and/or the input/output devices. The I/O controller 514 may include one or more integrated circuits and may be integrated within the control circuit 516 or exist as a separate component. The I/O controller 514 may provide the infrastructure for communicating with the display 504, the keypad 502, and/or the reader 506. The I/O controller 514 may also provide the infrastructure for communicating with external devices.

In some embodiments, the user device 500 may be a mobile device. For example, the mobile device may be, but is not limited to, a mobile phone (for example a model of an iPhone®, or a derivative thereof, available from Apple Inc.; a model of a Blackberry®, or a derivative thereof, available from RIM Inc.; a model of a Galaxy®, or a derivative thereof, available from Samsung Inc.), a tablet computer (for example a model of an iPad®, or a derivative thereof, available from Apple Inc.; a model of a Galaxy Tab®, or a derivative thereof, available from Samsung Inc.; a model of a PlayBook®, or a derivative thereof, available from RIM Inc.), and a laptop computer. To facilitate transport and ease of motion, the user device 500 may include an integrated power source for powering the user device 500. The power source may include one or more batteries, such as a Li-ion battery, which may be user-removable or secured to the user device 500.

In alternative embodiments, the secure element 510, the wireless interface 512, the reader 506, or some combination thereof may be embedded on non-mobile devices.

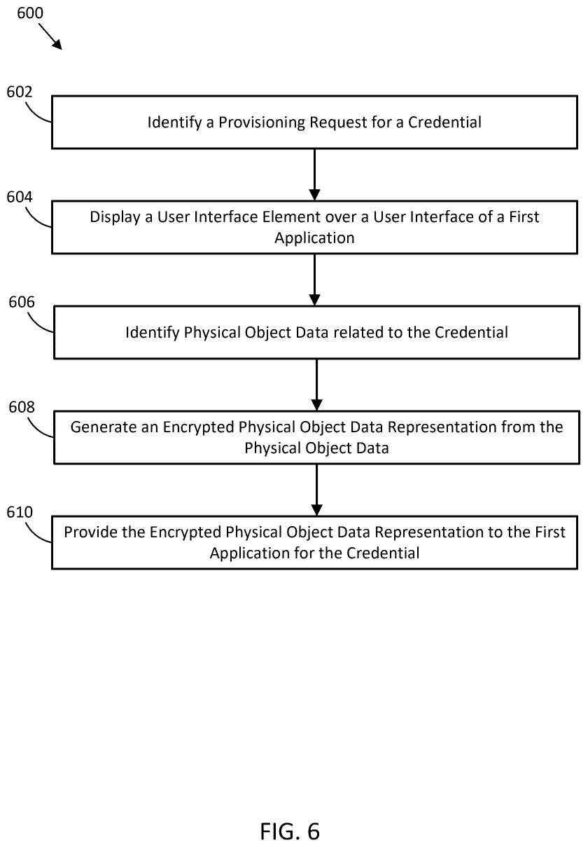

FIG. 6 illustrates an example procedure 600 for provisioning a credential in accordance with some embodiments. In other instances, the procedure 600 may be performed for verifying a credential for other purposes.

The procedure 600 may include identifying a provisioning request for a credential in 602. For example, a first application executing on a user device may identify the provision request for the credential.

In some embodiments, the procedure 600 may further include identifying a first application identifier corresponding to the first application. Further, the procedure 600 may include verifying entitlements of the first application for provisioning of the credential based at least in part on the first application identifier.

The procedure 600 may include displaying a user interface element over a user interface of the first application in 604. For example, a second application corresponding to a secure element of the user device may display a user interface element over a user interface of the first application. The second application may prevent the first application from accessing at least a portion of data received by the user device while the user interface element is displayed over the user interface.

In some embodiments, the first application may include a first copy of an application programming interface (API) and the second application may include a second copy of the API. Displaying the user interface element over the first application may include utilizing the first copy of the API within the first application and the second copy of the API within the second application to facilitate displaying the user interface element over the first application. In some of these embodiments, the first copy of the API and the second copy of the API may provide sandboxing when the user interface element is being displayed to prevent the first application from accessing the at least the portion of the data received by the user device while the user interface element is displayed over the user interface.

The procedure 600 may include identifying physical object data related to the credential in 606. For example, the secure element of the user device may identify physical object data related to the credential. The physical object data may be received from a physical object associated with the credential in accordance with the credential being moved within a proximity of the user device at a time when the user interface element is being displayed.

The procedure 600 may include generating an encrypted physical object data representation for the physical object data in 608. For example, the secure element of the user device may generate an encrypted physical object data representation from the physical object data. In some embodiments, the first application may be unable to decrypt the encrypted data tap representation.

In some embodiments, the procedure 600 may further include identifying, by the secure element, encryption information from the second application. Generating the encrypted data tap representation includes encrypting the physical object data using the encryption information to generate the encrypted physical object data representation. In some of these embodiments, the encryption information may include a nonce, a country code, or a currency code.

The procedure 600 may include providing the encrypted physical object data representation to the first application for the credential in 610. For example, the secure element of the user device may provide the encrypted physical object data representation to the first application for the credential. In some embodiments, the procedure 600 may further include providing, by the first application, the encrypted physical object data representation to an external server for decryption of the encrypted physical object data representation.

In some embodiments, the procedure 600 may include identifying a set of keys received from a service provider corresponding to the credential. Further, the procedure 600 may include generating, by the secure element, a cryptogram for authorization for accessing the first application based at least part on the set of keys. The procedure 600 may include providing, by the secure element, the cryptogram to the first application.

Any one or more of the operations in FIG. 6 may be performed in a different order than shown and/or one or more of the operations may be performed concurrently in embodiments. Further, it should be understood that one or more of the operations may be omitted from and/or one or more additional operations may be added to the procedure 600 in other embodiments.

FIG. 7 illustrates an example architecture or environment 700 configured to implement techniques described herein in accordance with some embodiments. The architecture 700 includes a user device 706 and a service provider computer 702. In some examples, the example architecture 700 may further be configured to enable the user device 706 and the service provider computer 702 to share information. In some examples, the devices may be connected via one or more networks 708 (e.g., via Bluetooth, WiFi, the Internet). In some examples, the service provider computer 702 may be configured to implement at least some of the techniques described herein with reference to the user device 706 and vice versa.

In some examples, the networks 708 may include any one or a combination of many different types of networks, such as cable networks, the Internet, wireless networks, cellular networks, satellite networks, other private and/or public networks, or any combination thereof. While the illustrated example represents the user device 706 accessing the service provider computer 702 via the networks 708, the described techniques may equally apply in instances where the user device 706 interacts with the service provider computer 702 over a landline phone, via a kiosk, or in any other manner. It is also noted that the described techniques may apply in other client/server arrangements (e.g., set-top boxes), as well as in non-client/server arrangements (e.g., locally stored applications, peer-to-peer configurations).

As noted above, the user device 706 may be any type of computing device such as, but not limited to, a mobile phone, a smartphone, a personal digital assistant (PDA), a laptop computer, a desktop computer, a thin-client device, a tablet computer, a wearable device such as a smart watch, an electronic device in a moveable vehicle or transport device, or the like. In some examples, the user device 706 may be in communication with the service provider computer 702 via the network 708, or via other network connections.

In one illustrative configuration, the user device 706 may include at least one memory 714 and one or more processing units (or processor(s)) 716. The processor(s) 716 may be implemented as appropriate in hardware, computer-executable instructions, firmware, or combinations thereof. Computer-executable instructions or firmware implementations of the processor(s) 716 may include computer-executable or machine-executable instructions written in any suitable programming language to perform the various functions described. The user device 706 may also include geo-location devices (e.g., a global positioning system (GPS) device or the like) for providing and/or recording geographic location information associated with the user device 706. In some examples, the processors 716 may include a GPU and a CPU.

The memory 714 may store program instructions that are loadable and executable on the processor(s) 716, as well as data generated during the execution of these programs. Depending on the configuration and type of the user device 706, the memory 714 may be volatile (such as random access memory (RAM)) and/or non-volatile (such as read-only memory (ROM), flash memory). The user device 706 may also include additional removable storage and/or non-removable storage 726 including, but not limited to, magnetic storage, optical disks, and/or tape storage. The disk drives and their associated non-transitory computer-readable media may provide non-volatile storage of computer-readable instructions, data structures, program modules, and other data for the computing devices. In some examples, the memory 714 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

The memory 714 and the additional storage 726, both removable and non-removable, are all examples of non-transitory computer-readable storage media. For example, non-transitory computer-readable storage media may include volatile or non-volatile, removable or non-removable media implemented in any method or technology for storage of information such as computer-readable instructions, data structures, program modules, or other data. The memory 714 and the additional storage 726 are both examples of non-transitory computer-storage media. Additional types of computer-storage media that may be present in the user device 706 may include, but are not limited to, phase-change RAM (PRAM), SRAM, DRAM, RAM, ROM, Electrically Erasable Programmable Read-Only Memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the user device 706. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

The user device 706 may also contain communications connection(s) 728 that allow the user device 706 to communicate with a data store, another computing device or server, user terminals, and/or other devices via the network 708. The user device 706 may also include I/O device(s) 730, such as a keyboard, a mouse, a pen, a voice input device, a touch screen input device, a display, speakers, and a printer.

Turning to the contents of the memory 714 in more detail, the memory 714 may include an operating system 712 and/or one or more application programs or services for implementing the features disclosed herein such as the third party application 108 (FIG. 1), the proximity reader kit 110 (FIG. 1), and/or the wallet application 112 (FIG. 1).

The service provider computer 702 may also be any type of computing device such as, but not limited to, a collection of virtual or “cloud” computing resources, a remote server, a mobile phone, a smartphone, a PDA, a laptop computer, a desktop computer, a thin-client device, a tablet computer, a wearable device, a server computer, or a virtual machine instance. In some examples, the service provider computer 702 may be in communication with the user device 706 via the network 708, or via other network connections.

In one illustrative configuration, the service provider computer 702 may include at least one memory 742 and one or more processing units (or processor(s)) 744. The processor(s) 744 may be implemented as appropriate in hardware, computer-executable instructions, firmware, or combinations thereof. Computer-executable instructions or firmware implementations of the processor(s) 744 may include computer-executable or machine-executable instructions written in any suitable programming language to perform the various functions described.

The memory 742 may store program instructions that are loadable and executable on the processor(s) 744, as well as data generated during the execution of these programs. Depending on the configuration and type of service provider computer 702, the memory 742 may be volatile (such as RAM) and/or non-volatile (such as ROM and flash memory). The service provider computer 702 may also include additional removable storage and/or non-removable storage 746 including, but not limited to, magnetic storage, optical disks, and/or tape storage. The disk drives and their associated non-transitory computer-readable media may provide non-volatile storage of computer-readable instructions, data structures, program modules, and other data for the computing devices. In some examples, the memory 742 may include multiple different types of memory, such as SRAM, DRAM, or ROM. While the volatile memory described herein may be referred to as RAM, any volatile memory that would not maintain data stored therein, once unplugged from a host and/or power, would be appropriate. The memory 742 and the additional storage 746, both removable and non-removable, are both additional examples of non-transitory computer-readable storage media.

The service provider computer 702 may also contain communications connection(s) 748 that allow the service provider computer 702 to communicate with a data store, another computing device or server, user terminals, and/or other devices via the network 708. The service provider computer 702 may also include I/O device(s) 750, such as a keyboard, a mouse, a pen, a voice input device, a touch input device, a display, speakers, and a printer.

Turning to the contents of the memory 742 in more detail, the memory 742 may include an operating system 752 and/or one or more application programs 741 or services for implementing the features disclosed herein.

FIG. 8 is a block diagram of an example computing device 800 that can implement the features and processes described throughout this disclosure in accordance with some embodiments. The computing device 800 is an example of the user device. The computing device 800 can include a memory interface 802, one or more data processors, image processors and/or central processing units 804, and a peripherals interface 806. The memory interface 802, the one or more processors 804 and/or the peripherals interface 806 can be separate components or can be integrated in one or more integrated circuits. The various components in the computing device 800 can be coupled by one or more communication buses or signal lines.

Sensors, devices, and subsystems can be coupled to the peripherals interface 806 to facilitate multiple functionalities. For example, a motion sensor 810, a light sensor 812, and a proximity sensor 814 can be coupled to the peripherals interface 806 to facilitate orientation, lighting, and proximity functions. Other sensors 816 can also be connected to the peripherals interface 806, such as a global navigation satellite system (GNSS) (e.g., GPS receiver), a temperature sensor, a biometric sensor, magnetometer or other sensing device, to facilitate related functionalities.

A camera subsystem 820 and an optical sensor 822 (e.g., a charged coupled device (CCD) or a complementary metal-oxide semiconductor (CMOS) optical sensor) can be utilized to facilitate camera functions, such as recording photographs and video clips. The camera subsystem 820 and the optical sensor 822 can be used to collect images of a user to be used during authentication of a user (e.g., by performing facial recognition analysis).

Communication functions can be facilitated through one or more wireless communication subsystems 824, which can include radio frequency receivers and transmitters and/or optical (e.g., infrared) receivers and transmitters. The specific design and implementation of the communication subsystem 824 can depend on the communication network(s) over which the computing device 800 is intended to operate. For example, the computing device 800 can include communication subsystems 824 designed to operate over a GSM network, a GPRS network, an EDGE network, a Wi-Fi or WiMax network, and a Bluetooth™ network.

An audio subsystem 826 can be coupled to a speaker 828 and a microphone 830 to facilitate voice-enabled functions, such as speaker recognition, voice replication, digital recording, and telephony functions. The audio subsystem 826 can be configured to facilitate processing voice commands, voice printing and voice authentication, for example.

The I/O subsystem 840 can include a touch-surface controller 842 and/or other input controller(s) 844. The touch-surface controller 842 can be coupled to a touch surface 846. The touch surface 846 and touch-surface controller 842 can, for example, detect contact and movement or break thereof using any of a plurality of touch sensitivity technologies, including, but not limited to, capacitive, resistive, infrared, and surface acoustic wave technologies, as well as other proximity sensor arrays or other elements for determining one or more points of contact with the touch surface 846.

The other input controller(s) 844 can be coupled to other input/control devices 848, such as one or more buttons, rocker switches, thumbwheel, infrared port, USB port, and/or a pointer device such as a stylus. The one or more buttons (not shown) can include an up/down button for volume control of the speaker 828 and/or the microphone 830.

In one implementation, a pressing of the button for a first duration can disengage a lock of the touch surface 846; and a pressing of the button for a second duration that is longer than the first duration can turn power to the computing device 800 on or off. Pressing the button for a third duration can activate a voice control, or voice command, module that enables the user to speak commands into the microphone 830 to cause the device to execute the spoken command. The user can customize a functionality of one or more of the buttons. The touch surface 846 can, for example, also be used to implement virtual or soft buttons and/or a keyboard.

In some examples, the computing device 800 can present recorded audio and/or video files, such as MP3, AAC, and MPEG files. In some examples, the computing device 800 can include the functionality of an MP3 player, such as an iPod™.

The memory interface 802 can be coupled to memory 850. The memory 850 can include high-speed random-access memory and/or non-volatile memory, such as one or more magnetic disk storage devices, one or more optical storage devices, and/or flash memory (e.g., NAND, NOR). The memory 850 can store an operating system 852, such as Darwin, RTXC, LINUX, UNIX, OS X, WINDOWS, or an embedded operating system such as VxWorks.

The operating system 852 can include instructions for handling basic system services and for performing hardware dependent tasks. In some examples, the operating system 852 can be a kernel (e.g., UNIX kernel). In some examples, the operating system 852 can include instructions for performing map data error correction. For example, operating system 852 can implement the procedures described throughout this disclosure.

The memory 850 can also store communication instructions 854 to facilitate communicating with one or more additional devices, one or more computers and/or one or more servers. The memory 850 can include graphical user interface instructions 856 to facilitate graphic user interface processing; sensor processing instructions 858 to facilitate sensor-related processing and functions; phone instructions 860 to facilitate phone-related processes and functions; electronic messaging instructions 862 to facilitate electronic-messaging related processes and functions; web browsing instructions 864 to facilitate web browsing-related processes and functions; media processing instructions 866 to facilitate media processing-related processes and functions; GNSS/Navigation instructions 868 to facilitate GNSS and navigation-related processes and instructions; and/or camera instructions 870 to facilitate camera-related processes and functions.

The memory 850 can store software instructions 872 to facilitate other processes and functions, such as the procedure described in relation to the representation (FIG. 1) and/or the procedure 600 (FIG. 6).

The memory 850 can also store other software instructions 874, such as web video instructions to facilitate web video-related processes and functions; and/or web shopping instructions to facilitate web shopping-related processes and functions. In some examples, the media processing instructions 866 are divided into audio processing instructions and video processing instructions to facilitate audio processing-related processes and functions and video processing-related processes and functions, respectively.

Each of the above identified instructions and applications can correspond to a set of instructions for performing one or more functions described above. These instructions need not be implemented as separate software programs, procedures, or modules. The memory 850 can include additional instructions or fewer instructions. Furthermore, various functions of the computing device 800 can be implemented in hardware and/or in software, including in one or more signal processing and/or application specific integrated circuits.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

As described above, one aspect of the present technology is the gathering, sharing, and use of data, including an authentication tag and data from which the tag is derived. The present disclosure contemplates that, in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to authenticate another device, and vice versa to control which device ranging operations may be performed. Further, other uses for personal information data that benefit the user are also contemplated by the present disclosure. For instance, health and fitness data may be shared to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence, different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of sharing content and performing ranging, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, users may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

In some examples, “circuitry” can refer to, be part of, or include hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

Although the present disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure. The use of “or” is intended to mean an “inclusive or,” and not an “exclusive or,” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

The specific details of particular embodiments may be combined in any suitable manner or varied from those shown and described herein without departing from the spirit and scope of embodiments of the described techniques.

The above description of example embodiments of the described techniques has been presented for the purposes of illustration and description. It is not intended to be exhaustive or to limit the described techniques to the precise form described, and many modifications and variations are possible in light of the teaching above. The embodiments were chosen and described in order to best explain the principles of the described techniques and its practical applications to thereby enable others skilled in the art to best utilize the described techniques in various embodiments and with various modifications as are suited to the particular use contemplated.

All publications, patents, and patent applications cited herein are hereby incorporated by reference in their entirety for all purposes.

### EXAMPLES

In the following sections, further example embodiments are provided.

Example 1 may include a method of provisioning a credential based on proximity, comprising identifying, by a first application executing on a user device, a provisioning request for the credential, displaying, by a second application corresponding to a secure element of the user device, a user interface element over a user interface of the first application, the second application preventing the first application from accessing at least a portion of data received by the user device while the user interface element is displayed over the user interface, identifying, by the secure element of the user device, physical object data related to the credential, the physical object data received from a physical object associated with the credential in accordance with the credential being moved within a proximity of the user device at a time when the user interface element is being displayed, generating, by the secure element of the user device, an encrypted physical object data representation from the physical object data, and providing, by the secure element of the user device, the encrypted physical object data representation to the first application for the credential.

Example 2 may include the method of example 1, wherein the first application includes a first copy of an application programming interface (API) and the second application includes a second copy of the API, and wherein displaying the user interface element over the first application includes utilizing the first copy of the API within the first application and the second copy of the API within the second application to facilitate displaying the user interface element over the first application.

Example 3 may include the method of example 2, wherein the first copy of the API and the second copy of the API provides sandboxing when the user interface element is being displayed to prevent the first application from accessing the at least the portion of the data received by the user device while the user interface element is displayed over the user interface.

Example 4 may include the method of any of examples 1-3, further comprising identifying, by the secure element, encryption information from the second application, wherein generating the encrypted data tap representation includes encrypting the physical object data using the encryption information to generate the encrypted physical object data representation.

Example 5 may include the method of example 4, wherein the encryption information includes a nonce, a country code, or a currency code.

Example 6 may include the method of any of examples 1-5, further comprising providing, by the first application, the encrypted physical object data representation to an external server for decryption of the encrypted physical object data representation.

Example 7 may include the method of any of examples 1-6, further comprising identifying a set of keys received from a service provider corresponding to the credential, generating, by the secure element, a cryptogram for authorization for accessing the first application based at least part on the set of keys, and providing, by the secure element, the cryptogram to the first application.

Example 8 may include the method of any of examples 1-7, further comprising identifying a first application identifier corresponding to the first application, and verifying entitlements of the first application for provisioning of the credential based at least in part on the first application identifier.

Example 9 may include the method of any of examples 1-8, wherein the first application is unable to decrypt the encrypted data tap representation.

Example 10 may include a user device, comprising memory configured to store instructions and one or more processors configured to execute the instructions to perform the method of any of examples 1-9.

Example 11 may include a non-transitory computer-readable medium comprising instructions stored thereon that, when executed by one or more processors of a user device, configure the user device to perform the method of any of examples 1-9.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method of provisioning a credential based on proximity, comprising:
identifying, by a first application executing on a user device, a provisioning request for the credential;
displaying, by a second application corresponding to a secure element of the user device, a user interface element over a user interface of the first application, the second application preventing the first application from accessing at least a portion of data received by the user device while the user interface element is displayed over the user interface;
identifying, by the secure element of the user device, physical object data related to the credential, the physical object data received from a physical object associated with the credential in accordance with the credential being moved within a proximity of the user device at a time when the user interface element is being displayed;
generating, by the secure element of the user device, an encrypted physical object data representation from the physical object data; and
providing, by the secure element of the user device, the encrypted physical object data representation to the first application for the credential.

2. The method of claim 1, wherein the first application includes a first copy of an application programming interface (API) and the second application includes a second copy of the API, and wherein displaying the user interface element over the first application includes utilizing the first copy of the API within the first application and the second copy of the API within the second application to facilitate displaying the user interface element over the first application.

3. The method of claim 2, wherein the first copy of the API and the second copy of the API provides sandboxing when the user interface element is being displayed to prevent the first application from accessing the at least the portion of the data received by the user device while the user interface element is displayed over the user interface.

4. The method of claim 1, further comprising:
identifying, by the secure element, encryption information from the second application, wherein generating the encrypted physical object data representation includes encrypting the physical object data using the encryption information to generate the encrypted physical object data representation.

5. The method of claim 4, wherein the encryption information includes a nonce, a country code, or a currency code.

6. The method of claim 1, further comprising:
providing, by the first application, the encrypted physical object data representation to an external server for decryption of the encrypted physical object data representation.

7. The method of claim 1, further comprising:
identifying a set of keys received from a service provider corresponding to the credential;
generating, by the secure element, a cryptogram for authorization for accessing the first application based at least part on the set of keys; and
providing, by the secure element, the cryptogram to the first application.

8. The method of claim 1, further comprising:
identifying a first application identifier corresponding to the first application; and
verifying entitlements of the first application for provisioning of the credential based at least in part on the first application identifier.

9. The method of claim 1, wherein the first application is unable to decrypt the encrypted physical object data representation.

10. One or more non-transitory computer-readable media having instructions that, when executed, cause a user device to:
identify, by a first application executing on the user device, a provisioning request for a credential;
display, by a second application corresponding to a secure element of the user device, a user interface element over a user interface of the first application, the second application preventing the first application from accessing at least a portion of data received by the user device while the user interface element is displayed over the user interface;
identify, by the secure element of the user device, physical object data related to the credential, the physical object data received from a physical object associated with the credential in accordance with the credential being moved within a proximity of the user device at a time when the user interface element is being displayed;
generate, by the secure element of the user device, an encrypted physical object data representation from the physical object data; and
provide, by the secure element of the user device, the encrypted physical object data representation to the first application for the credential.

11. The one or more non-transitory computer-readable media of claim 10, wherein the first application includes a first copy of an application programming interface (API) and the second application includes a second copy of the API, and wherein displaying the user interface element over the first application includes utilizing the first copy of the API within the first application and the second copy of the API within the second application to facilitate displaying the user interface element over the first application.

12. The one or more non-transitory computer-readable media of claim 10, wherein the instructions, when executed, further cause the user device to:
identify, by the secure element, encryption information from the second application, wherein generating the encrypted physical object data representation includes encrypting the physical object data using the encryption information to generate the encrypted physical object data representation.

13. The one or more non-transitory computer-readable media of claim 10, wherein the instructions, when executed, further cause the user device to:
provide, by the first application, the encrypted physical object data representation to an external server for decryption of the encrypted physical object data representation.

14. The one or more non-transitory computer-readable media of claim 10, wherein the instructions, when executed, further cause the user device to:
identify a set of keys received from a service provider corresponding to the credential;
generate, by the secure element, a cryptogram for authorization for accessing the first application based at least part on the set of keys; and
provide, by the secure element, the cryptogram to the first application.

15. The one or more non-transitory computer-readable media of claim 10, wherein the instructions, when executed, further cause the user device to:
identify a first application identifier corresponding to the first application; and
verify entitlements of the first application for provisioning of the credential based at least in part on the first application identifier.

16. The one or more non-transitory computer-readable media of claim 10, wherein the first application is unable to decrypt the encrypted physical object data representation.

17. A user device, comprising:
one or more processors to:
identify, via a first application executing on the user device, a provisioning request for a credential;
display, via a second application corresponding to a secure element of the user device, a user interface element over a user interface of the first application, the second application preventing the first application from accessing at least a portion of data received by the user device while the user interface element is displayed over the user interface;
the secure element coupled to the one or more processors, the secure element to:
identify physical object data related to the credential, the physical object data received from a physical object associated with the credential in accordance with the credential being moved within a proximity of the user device at a time when the user interface element is being displayed;
generate an encrypted physical object data representation from the physical object data; and
provide the encrypted physical object data representation to the first application for the credential.

18. The user device of claim 17, wherein the first application includes a first copy of an application programming interface (API) and the second application includes a second copy of the API, and wherein displaying the user interface element over the first application includes utilizing the first copy of the API within the first application and the second copy of the API within the second application to facilitate displaying the user interface element over the first application.

19. The user device of claim 17, wherein the secure element is further to:
identify encryption information from the second application, wherein generating the encrypted physical object data representation includes encrypting the physical object data using the encryption information to generate the encrypted physical object data representation.

20. The user device of claim 17, wherein the secure element is further to:
generate a cryptogram for authorization for accessing the first application based at least part on a set of keys, received from a service provider, corresponding to the credential; and
provide the cryptogram to the first application.
